(19) United States
(12) Patent Application Publication
(10) Pub. No.: US 2014/0358955 A1
(43) Pub. Date: Dec. 4, 2014

(54) MEDIA RETRIEVAL METHOD

(71) Applicants: INVENTEC CORPORATION, Taipei (TW); Inventec (Pudong) Technology Corporation, Shanghai (CN)

(72) Inventor: Tzu-Chiang CHANG, Taipei (TW)

(73) Assignees: INVENTEC CORPORATION, Taipei (TW); Inventec (Pudong) Technology Corporation, Shanghai (CN)

(21) Appl. No.: 14/242,478

(22) Filed: Apr. 1, 2014

(30) Foreign Application Priority Data
May 28, 2013 (CN) 201310204941.2

(51) Int. Cl. G06F 17/30

(52) U.S. Cl. CPC G06F 17/3082; G06F 17/3079
USPC 707/758

(57) ABSTRACT

The disclosure provides a media retrieval method. The media retrieval method is applicable to a media database. The media retrieval method includes: receiving a retrieval request; determining according to the retrieval request whether the media database has at least one piece of media description data that matches the retrieval request; if the media database has at least one piece of media description data, determining whether the media database has at least one piece of media data corresponding to the media description data; if the media database does not have the media data, requesting the media data from a remote device according to the media description data; and if the media database has the media data, capturing at least one screenshot of the media data.

### CROSS-REFERENCE TO RELATED APPLICATIONS

This non-provisional application claims priority under 35 U.S.C. §119(a) on Patent Application No(s). 201310204941.2 filed in the P.R.O.C. on May 28, 2013, the entire contents of which are hereby incorporated by reference.

### BACKGROUND

1. Technical Field

The disclosure relates to a media retrieval method, and more particularly, to a media retrieval method for a drive recorder.

2. Related Art

Currently, the real-time road monitoring system and drive recorder are most commonly used in the field of traffic safety and driving safety. However, common road image systems are fixed devices and are bearing the test of regional popularity and time endurance. The drive recorder can only provide driving record for the driver and cannot be effectively used by other people. The usage of the two devices in the field of traffic safety and driving safety is usually limited.

Currently, the common road image system is only set for important road sections. The camera angle thereof is fixed in most cases, and even movable photographic equipment, if available, is limited within partial range in most cases. The photographic equipment is mostly fixed on a telegraph pole with a top-down angle, and cannot clearly identify a license plate, a vehicle number and a vehicle type that generally need to be photographed.

Although a drive recorder is generally combined with a navigation system, the drive recorder can only monitor a current driving condition of the user, but cannot provide the current driving condition to other people who want to inquire about or see the current driving condition. The memory configured in the drive recorder has a limited capacity. In order to continue the monitoring operation, old data is usually cleared or covered by new data. Therefore, when some user is in need of the old data, the data is usually no longer available.

Nowadays, some driving record clips are available for query on the Internet; however, these driving record clips are uploaded and used by individual users only, and no query interface is provided to other people. In spite of the good intention of sharing, there is no substantial effect.

Therefore, in today's society where the traffic is increasingly complex, it is necessary to face up to and solve the problem of finding a set of media retrieval and indexing methods that can be used by those in need to search for media, so that users can search for required content in driving record information, and drivers who are willing to share driving record information can upload data.

### SUMMARY

In view of the above problem, the disclosure provides a media retrieval method for helping a user acquire a clear driving video record file and assisting the user in sharing and uploading the driving video record file, so as to effectively avoid the difficulty in management and search of a driving record video or difficulty in sharing a driving record video.

The media retrieval method according to an embodiment of the disclosure is applicable to a media database. The media retrieval method comprises the following steps: receiving a retrieval request; determining whether the media database has at least one piece of media description data according to the retrieval request, the at least one piece of media description data corresponding to the retrieval request; if the media database has the at least one piece of media description data, determining whether the media database has at least one piece of media data, the at least one piece of media data corresponding to the at least one piece of media description data; if the media database does not have the at least one piece of media data, requesting the at least one piece of media data from a remote device according to the at least one piece of media description data; and if the media database has the at least one piece of media data, capturing at least one screenshot of the at least one piece of media data.

In an embodiment of the disclosure, the retrieval information and the at least one piece of media description data comprise a vehicle number, a road name, a scenic spot name, global positioning system information, a latitude and longitude coordinate, time, and a time segment.

In an embodiment of the disclosure, the remote device is a drive recorder, a monitor, a camera and a driving device having a video recording function.

In an embodiment of the disclosure, the at least one video screenshot is a thumbnail smaller than the size of at least one piece of video content, a full-scale drawing, and an enlarged drawing.

In an embodiment of the disclosure, the media retrieval method further comprises classifying and indexing the at least one piece of media data in the media database according to the at least one piece of media description data.

In an embodiment of the disclosure, the media retrieval method further comprises simultaneously uploading the at least one piece of media description data and the at least one piece of media data of the media database by the remote device regularly or irregularly, the at least one piece of media description data corresponding to the at least one piece of media data.

In an embodiment of the disclosure, when uploading the at least one piece of media description data, the remote device does not upload the at least one piece of media data corresponding to the at least one piece of media description data simultaneously, and uploads the at least one piece of media data when the media database requests the at least one piece of media data from the remote device.

In an embodiment of the disclosure, the at least one piece of media description data is converted into a latitude and longitude coordinate and stored in the media database.

In an embodiment of the disclosure, the at least one piece of media description data is converted into a name and position of a road and stored in the media database.

In the media retrieval method according to the disclosure, it is determined, according to a retrieval request, whether a media database has a piece of media description data corresponding to the retrieval request; when the media database has at least one piece of media description data, it is further determined whether the media database has at least one piece of media data, the at least one piece of media data corresponding to the at least one piece of media description data; if the media database does not have at least one piece of media data, the at least one piece of media data is requested from a remote device according to the at least one piece of media description data; and if the media database has the at least one piece of media data, at least one screenshot of the at least one piece of media data is captured. Therefore, when a user is in need of media data of a driving record, the user acquires the media data from drive recorders of other people; hence, usage and sharing are made more convenient.

### BRIEF DESCRIPTION OF THE DRAWINGS

The present disclosure will become more fully understood from the detailed description given herein below for illustration only, and thus does not limit the present disclosure, wherein:

FIG. 1 is an architectural diagram of a media retrieval system according to an embodiment of the disclosure;

FIG. 2 is a flow chart of a media retrieval method according to an embodiment of the disclosure;

FIG. 3 is a flow chart of a media retrieval method according to another embodiment of the disclosure;

FIG. 4 is a view showing an example of media retrieval according to an embodiment of the disclosure;

FIG. 5 is a view showing an example of media retrieval according to another embodiment of the disclosure;

FIG. 6 is a view showing an example of media uploading according to an embodiment of the disclosure;

FIG. 7 is a view showing an example of media browsing according to an embodiment of the disclosure;

FIG. 8 is a view showing an example of media browsing according to another embodiment of the disclosure; and

FIG. 9 is a view showing an example of browsing through media thumbnails according to another embodiment of the disclosure.

### DETAILED DESCRIPTION

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure. The following embodiments are intended to describe the disclosure in further detail, but not intended to limit the scope of the disclosure in any way.

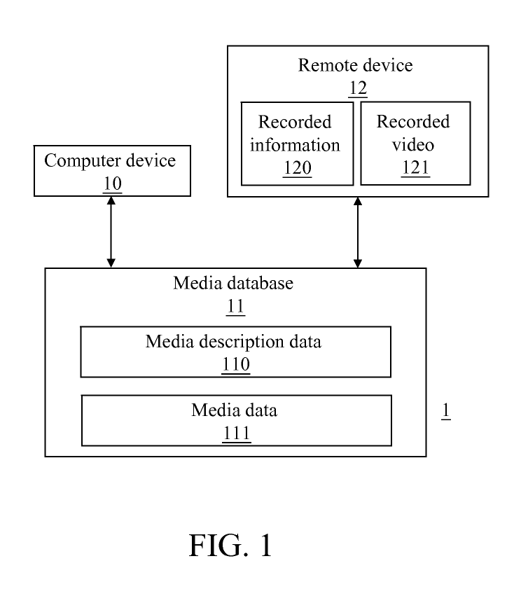

Referring to FIG. 1, FIG. 1 is an architectural diagram of a media retrieval system according to an embodiment of the disclosure. A media retrieval system 1 comprises a computer device 10, a media database 11, and a remote device 12. The media database 11 comprises a piece of media description data 110 and a piece of media data 111. The remote device 12 comprises a piece of recorded information 120 and a recorded video 121. The computer device 10 is connected to the media database 11 through, for example, a wired or wireless network, and the media database 11 is also connected to the remote device 12 in a wired or wireless manner.

The computer device 10 sends a retrieval request to the media database 11, and receives a retrieval result from the media database 11. The retrieval results are mostly video and audio content such as a video clip, so the computer device 10 has an audio and video playing unit used for playing the retrieval result. The computer device 10 is, for example, a desktop computer, a notebook computer, or a tablet computer.

The media database 11 comprises the media description data 110 and the media data 111, and the media description data 110 is used as a classification index corresponding to the media data 111. The media database 11 is, for example, a relational database or a non-relational database. The media data 111 and a system of the media database 11 are stored together or separately. The media database 11 is, for example, operated in a dedicated storage server. The media description data 110 is the index and classification of the media database 11, and comprises, for example, a vehicle number, a road name, a scenic spot name, global positioning system information, a latitude and longitude coordinate, time, and a time segment. The retrieval request received by the media database 11 also comprises the above information, and the media data 11 is, for example, video and audio, a video signal, a video, a video image, a video record, and moving pictures.

The remote device 12 transmits the recorded information 120 and the recorded video 121 to the media database 11, and the remote device 12 also receives a request from the media database 11. The media database 11 uses the recorded information 120 and the recorded video 121 to establish the media description data 110 and the media data 111. The remote device 12 transmits the recorded information 120 to the media database 11 regularly or irregularly and determines whether to upload the recorded video 121 together according to a connection state. The remote device 12 can be, for example, a video Event Data Recorder (EDR) with connection function and satellite navigation, or a drive recorder; or can furthermore be, for example, a computer device storing the driving information and a global satellite navigation device. The recorded information 120 is information such as a vehicle number, a road name, a scenic spot name, global positioning system information, a latitude and longitude coordinate, time, and a time segment. The recorded video 121 is a recorded driving video.

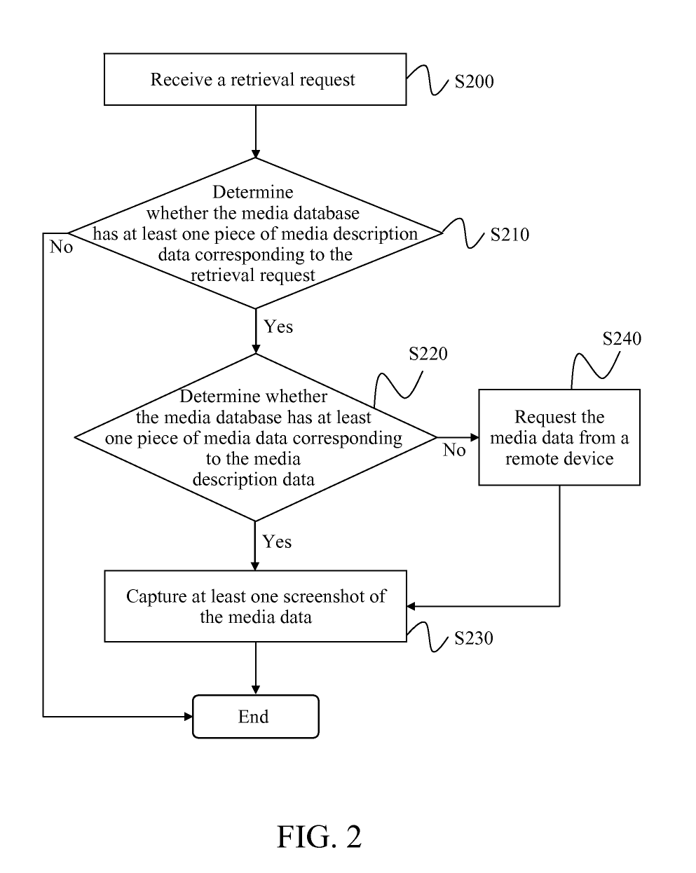

Referring to FIG. 1 and FIG. 2 together, FIG. 2 is a flow chart of a media retrieval method according to an embodiment of the disclosure.

In step S200, a media database 11 receives a retrieval request from a computer device 10. The retrieval request comprises, for example, a vehicle number, a road name, a scenic spot name, global positioning system information, a latitude and longitude coordinate, time, and a time segment. The media database 11 provides a related retrieval function to a user in an operation interface thereof.

In step S210, after receiving the retrieval request, the media database 11 compares information such as the vehicle number, road name, scenic spot name, global positioning system information, latitude and longitude coordinate, time, and time segment in the retrieval request with media description data 110; if the media database 11 does not have media description data 110 corresponding the retrieval request, a user is informed that the data does not exist and the retrieval is ended; and if the media database 11 has media description data 110 corresponding to the retrieval request, the procedure proceeds to step S220.

In step S220, after the comparison is performed on the media description data 110 according to the retrieval request, data conforming to the retrieval request is determined among the media description data 110. Then media data corresponding to the media description data 110 conforming to the retrieval request is searched for in the media data 111, and if the media data 111 corresponds to the media description data 110 is found, the procedure proceeds to step S230.

In step S230, the media database 11 has the media data 111 corresponding to the media description data 110, and then a screenshot is captured in the media data 111 and used as a reference for the user. The resolution of the screenshot is adjusted according to a browse requirement of the user

In another aspect, if the media database 11 does not have the media data 111 corresponding to the media description data 110, the procedure proceeds to step S240. In step S240, the media database 11 does not have the media data 111 corresponding to the retrieval request, but has the corresponding media description data 110. The media database 11 sends a request to a remote device 12 having the required media data 111 according to the media description data 110, so that the remote device 12 transmits a recorded video 121 to the media database 11.

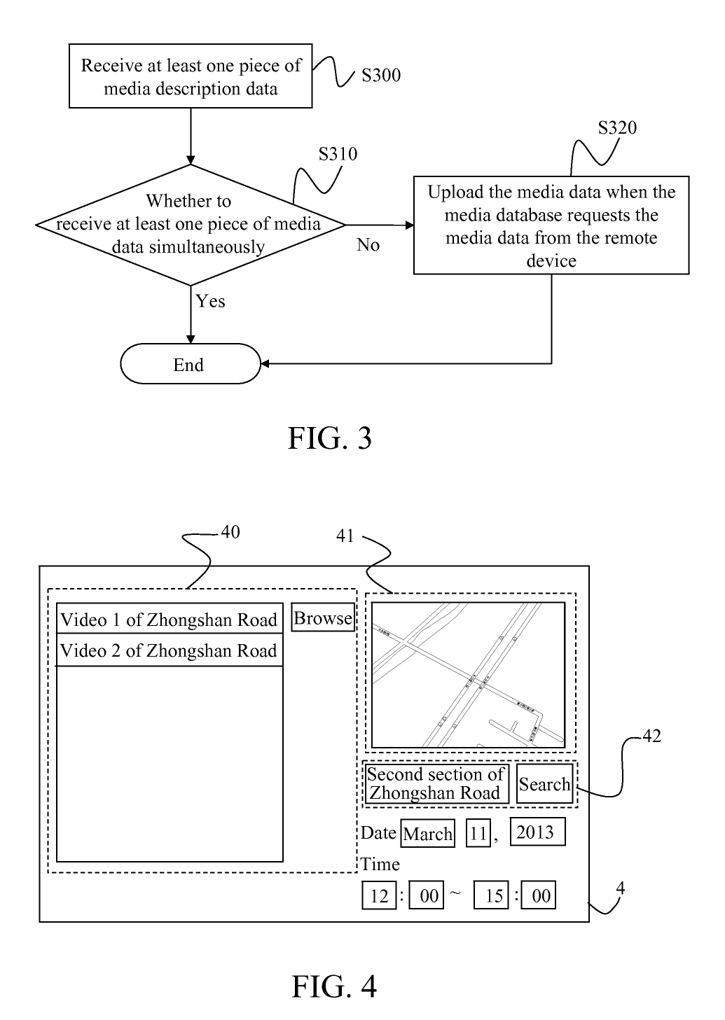

Referring to FIG. 1 and FIG. 3 together, FIG. 3 is a flow chart of a media retrieval method according to another embodiment of the disclosure.

In step S300, the remote device 12 proactively or passively uploads recorded information 120. The recorded information 120 comprises, for example, at least one piece of media description data 110 such as information about a vehicle number, a road name, a scenic spot name, global positioning system information, a latitude and longitude coordinate, time, and a time segment. The remote device 12, for example, is further set to upload the recorded information 120 regularly or irregularly. The data class and pattern of the recorded information 120 are corresponding to a data field of the media description data 110 in the media database 11.

In step S310, the media database 11 determines whether the data transmitted from the remote device 12 has at least one piece of media data 111 corresponding to at least one piece of media description data 110, namely, a recorded video 121 in the corresponding remote device 12. When uploading the recorded information 120, the remote device 12 determines whether to upload the recorded video 121 together according to a current network connection condition or bandwidth, and uploads the recorded video 121 together if the network bandwidth permits.

The media database 11 stores the recorded information 120 in the media description data 110, stores the recorded video 121 in the media data 111, and records a corresponding relationship. If the network bandwidth is insufficient or the network is disconnected, only the recorded information 120 is stored in the media description data 110, and the recorded video 121 corresponding to the recorded information 120 is not uploaded. Moreover, the corresponding media description data 110 is annotated with “not uploaded”. If the recorded information 120 and the recorded video 121 are uploaded together, the procedure is ended; otherwise, the procedure proceeds to the next step.

In step S320, when a user operating the media database 11 intends to browse the media data 111 corresponding to the media description data 110, but the media database 11 does not have the media data 111, the media database 11 requests the media data 111 from the remote device 12 according to the corresponding media description data 110. At this time, the remote device 12 uploads the corresponding recorded video 121 in response to the request of the media database 11.

The remote device 12 is, for example, a drive record integrated with global satellite navigation. The remote device 12 is disposed in a vehicle, and for example, is set to upload the recorded information 120 to the media database 11 every five minutes, so that the recorded information 120 is used as the media description data 110.

When a vehicle travels through a remote mountainous region or a region with poor reception condition, due to the poor reception condition, the bandwidth of the network connection of the remote device 12 is reduced. At this time, the remote device 12 only uploads the recorded information 120 to the media database 11, stores the recorded information 120 as the media description data 110 of the media database 11, and marks in the media description data 110 that the corresponding media data 111 is not uploaded. Identification data stored in the remote device 12 is, for example, a vehicle number or a physical machine code of a machine. In the media database 11, the media data 111 is corresponding to media description data 110 and will be uploaded by batches when the reception condition becomes good, or uploaded as required by the media database 11.

If the remote device 12 does not have a wireless network function, the remote device 12 stores the recorded information 120 and the recorded video 121 when a user is driving a vehicle. After finishing driving, the user can connect the remote device 12 to the network and upload the stored recorded information 120 and recorded video 121 to the media database 11 all at once.

Referring to FIG. 4, FIG. 4 is a view showing an example of media retrieval according to an embodiment of the disclosure. A media retrieval interface 4 comprises a video browse list 40, a map query interface 41 and a search field 42, and is used for querying the media database. The interface is merely a conceptual architecture, but not an actual program interface. In this embodiment, the user enters in the search field 42 a road section to be searched for, or other keywords conforming to the media description data, for example, information such as a vehicle number, a road name, a scenic spot name, global positioning system information, a latitude and longitude coordinate, time, and a time segment. After entering a retrieval request in the search field 42, the user presses a search key, and a query result is output at the video browse list 40 on the left side and the map query interface 41 on the upper side. The user further uses the map query interface 41 to query for more details. In this embodiment, the user clicks any point in the map query interface 41 to acquire a closer position.

Related videos that can be browsed are listed in the video browse list 40 so as to be clicked by the user. The map query interface 41 further combines common map software such as Google Map, to make it more convenient for the user to operate the map query interface 41. The map query interface 41 further marks a road section or a range having a driving record video on a map, so as to increase the interactivity between the user and the map query interface 41 during operation. The back-end processing of the map query interface 41 converts the road section or range into latitude and longitude or a satellite navigation coordinate for further calculation.

In this embodiment, the user enters “second section of Zhongshan Road” in the search field 42, and the back-end processing converts the “second section of Zhongshan Road” into a coordinate or a latitude and longitude, and compares the coordinate or the latitude and longitude with the media description data in the media database to check whether some of the media description data matches the coordinate or the latitude and longitude, so as to list the corresponding video in the video browse list 40. Then the map query interface 41 is switched to an area near the “second section of Zhongshan Road”, so that the user can perform further operations. The user can click the point in the map query interface 41 to obtain more detailed data or drag the map in the map query interface 41 to search for related information nearby.

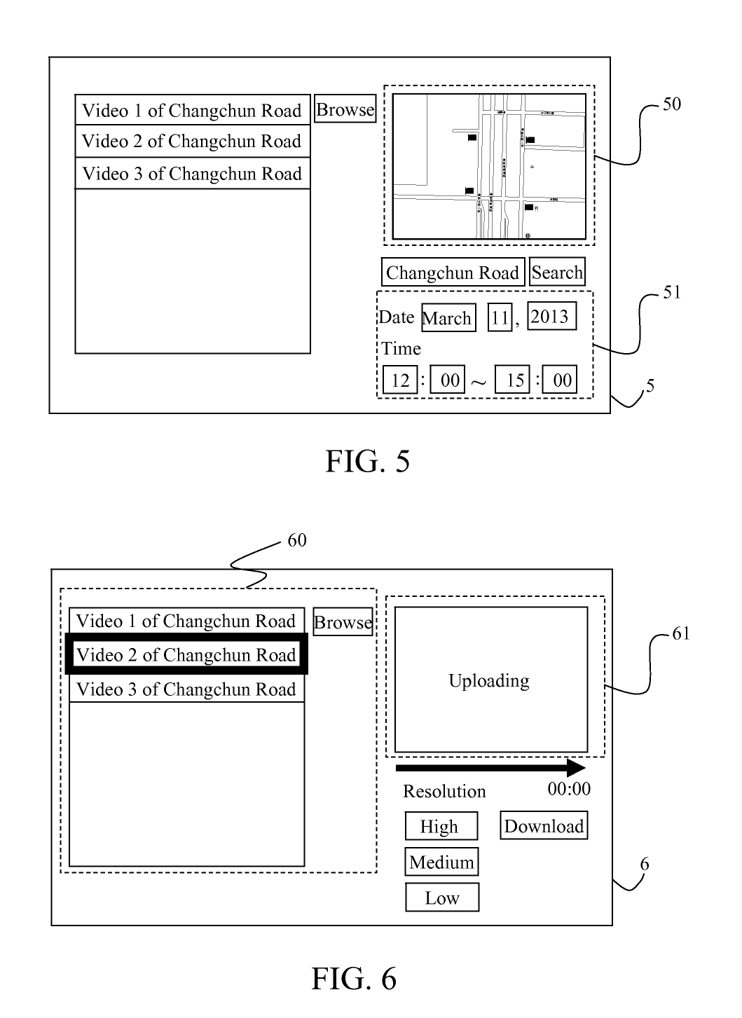

Referring to FIG. 5, FIG. 5 is a view showing an example of media retrieval according to another embodiment of the disclosure. A media retrieval interface 5 comprises a map query interface 50 and a time query interface 51. A user first selects a fixed road section and range in the map query interface 50; however, the media database may have too many driving record videos about the road section, so a time range is added to reduce the number of driving record videos, so as to make the selection easier for the user. In this and some embodiments, the media database is further combined with a road section monitoring system of the government and public institutions, and a position of a monitor system is displayed in the map query interface 50. When clicking the point in the map query interface 50, the user can also view corresponding media data, thereby further improving the convenience for the user.

In this embodiment, driving record videos related to “Changchun Road” are targeted. The road is an important artery, so a great number of driving record videos are obtained. At this time, the user enters a time segment to be queried for in the time query interface 51. In this embodiment, the user enters 12:00 to 15:00, Mar. 11, 2013, and at the same time, the map query interface 50 further displays monitoring points from combining road section monitoring systems of the government and public institutions, so the user can further click the monitoring point to browse the related video.

Referring to FIG. 6, FIG. 6 is a view showing an example of media uploading according to an embodiment of the disclosure. A media retrieval interface 6 comprises a video browse list 60 and a video playing interface 61. A user clicks a video to be watched through the video browse list 60, but the video is not stored in a media database. The media database only stores related media description data, but no media content. Therefore, the media database queries the corresponding media description data to find out data that can identify a remote device, for example, a license plate or a physical machine address of a drive recorder. The media database proactively sends a request to the remote device, and then the media database receives required media content from the remote device.

In this embodiment, the user clicks “video 2 of Changchun Road”, and the media database does not have the media content, but only has media description data. Therefore, the media database requests the drive recorder to upload the video. The video playing interface 61 indicates that the video is being uploaded, and the video can be viewed after the uploading is completed.

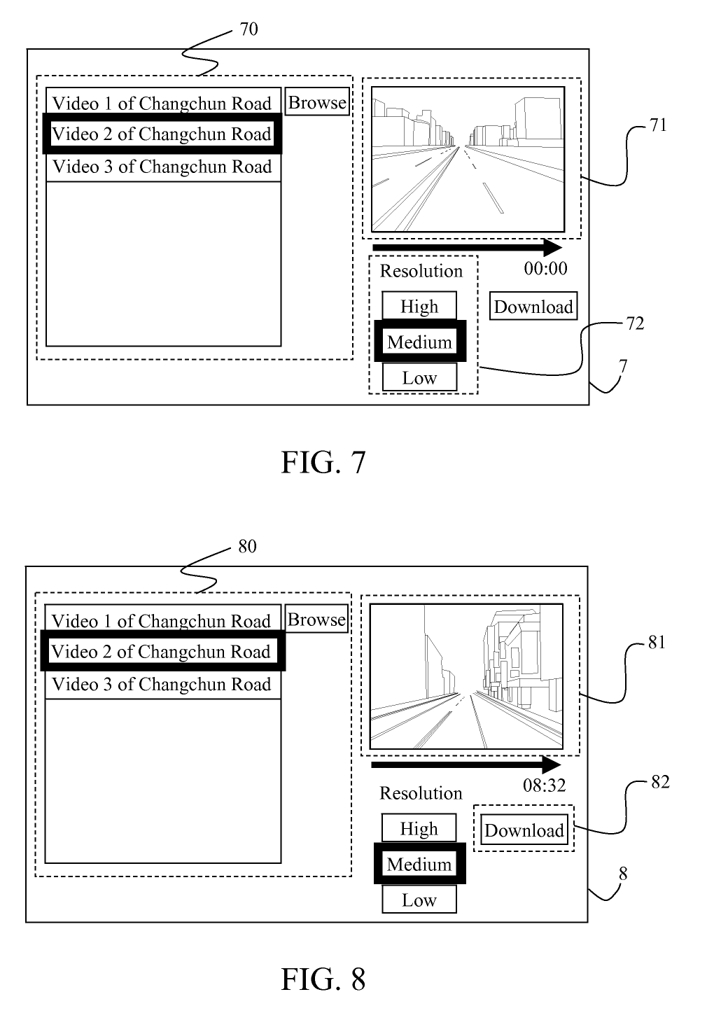

Referring to FIG. 7, FIG. 7 is a view showing an example of media browse according to an embodiment of the disclosure. A media retrieval interface 7 comprises a video browse list 70, a playing interface 71 and a resolution setting interface 72. A user clicks a video to be browsed in the video browse list 70. The media database has the video, so the video playing interface 71 first displays a screenshot of the video. For example, the screenshot is played in turn, or a representative screenshot is displayed in the video playing interface 71, or a plurality of screenshots is displayed once. However, in this embodiment, displaying a representative screenshot is taken as an example. The resolution of the screenshot is further adjusted through the resolution setting interface 72, and the user can use a screenshot with high resolution to confirm whether it is the video content required.

In this embodiment, the user clicks “video 2 of Changchun Road”; the video playing interface 71 displays the representative screenshot, and the user sets the resolution to “Medium” through the resolution setting interface 72, so as to view characteristics in the video.

Referring to FIG. 8, FIG. 8 is a view showing an example of media browse according to another embodiment of the disclosure. A media retrieval interface 8 comprises a video browse list 80, a video playing interface 81, and a download button 82. After confirming a video to be watched, the user downloads the video through the download button 82. Generally, the application for a monitoring video undergoes a lot of procedures; therefore, online download simplifies the procedures and saves time.

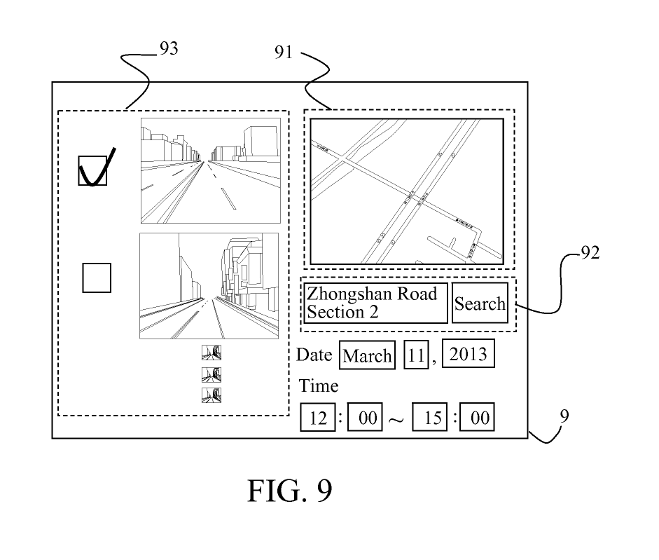

Referring to FIG. 9, FIG. 9 is a view showing an example of browsing through media thumbnails according to another embodiment of the disclosure. A media retrieval interface 9 comprises a map query interface 91 and a search field 92. A user first selects a fixed road section and range in the map query interface 91; however, the media database may have too many driving record videos about the road section, so a time range is added to reduce the number of driving record videos, so as to make the selection easier for the user. In this and some embodiments, the media database is further combined with a road section monitoring system of the government and public institutions, and a position of a monitor system is displayed in the map query interface 91. When clicking the point in the map query interface 91, the user can also view corresponding media data, thereby further improving the convenience for the user.

In this embodiment, driving record videos related to “Zhongshan Road Section 2” are targeted. The road is an important artery, so a great number of driving record videos are obtained. The left side of the media retrieval interface 9 is a media thumbnail browsing interface 93, which provides fast browsing by utilizing thumbnails of the driving record video. Among driving record videos or videos from fixed video cameras of the same place, some of the filming angles are not what the user is looking for. At this time, the media thumbnail browse interface 93 can be used for fast filtering, by allowing the user to select from thumbnails of various angles. After selecting the thumbnails of interest, the user further proceeds to the next step of setting of the resolution of the thumbnails as described previously, for further confirmation.

The media retrieval method according to the disclosure, determines according to a retrieval request, whether a media database has a piece of media description data corresponding to the retrieval request; when the media database has at least one piece of media description data, the method determines whether the media database has at least one piece of media data corresponding to the at least one piece of media description data; if the media database does not have at least one piece of media data, the at least one piece of media data is requested from a remote device according to the at least one piece of media description data; and if the media database has the at least one piece of media data, at least one screenshot of the at least one piece of media data is captured. Therefore, when a user is in need of media data of a driving record, the user acquires the media data from drive recorders of other people; hence, usage and sharing are made more convenient.

What is claimed is:

1. A media retrieval method, applied to a media database, comprising:
receiving a retrieval request;
determining, according to the retrieval request, whether the media database has at least one piece of media description data, the at least one piece of media description data corresponding to the retrieval request;
when the media database has the at least one piece of media description data, determining whether the media database has at least one piece of media data, the at least one piece of media data corresponding to the at least one piece of media description data;
when the media database does not have the at least one piece of media data, requesting the at least one piece of media data from a remote device according to the at least one piece of media description data; and
when the media database has the at least one piece of media data, capturing at least one screenshot of the at least one piece of media data.

2. The media retrieval method according to claim 1, wherein the retrieval information and the at least one piece of media description data comprise a vehicle number, a road name, a scenic spot name, global positioning system information, a latitude and longitude coordinate, time, and a time segment.

3. The media retrieval method according to claim 1, wherein the remote device is an event data recorder, a surveillance camera, a video camera, or a driving device with a video recording function.

4. The media retrieval method according to claim 1, wherein the at least one video screenshot is a thumbnail that is smaller than the size of video content, a full-scale image, or an enlarged image.

5. The media retrieval method according to claim 1, further comprising classifying and indexing the at least one piece of media data in the media database according to the at least one piece of media description data.

6. The media retrieval method according to claim 1, further comprising simultaneously uploading the at least one piece of media description data and the at least one piece of media data of the media database by the remote device periodically or irregularly, where the at least one piece of media description data corresponds to the at least one piece of media data.

7. The media retrieval method according to claim 1, wherein when uploading the at least one piece of media description data, the remote device does not upload the at least one piece of media data corresponding to the at least one piece of media description data simultaneously, and uploads the at least one piece of media data when the media database requests the at least one piece of media data from the remote device.

8. The media retrieval method according to claim 1, wherein the at least one piece of media description data is converted into a latitude and longitude coordinate and stored in the media database.

9. The media retrieval method according to claim 1, wherein the at least one piece of media description data is converted into a name and position of a road and stored in the media database.
